(19) United States
(12) Patent Application Publication
(10) Pub. No.: US 2023/0107457 A1
(43) Pub. Date: Apr. 6, 2023

(54) COMBUSTIBLE CONTAINERS MANUFACTURED USING REACTIVE INJECTION MOLDING OF AZIDO POLYMERS

(71) Applicant: General Dynamics Ordnance and Tactical System - Canada of Valleyfield Inc., Salaberry-de-Valleyfield (CA)

(72) Inventors: Etienne Comtois, Montreal (CA); Charles Dubois, Brossard (CA); Pierre-Yves Paradis, Salaberry-de-Valleyfield (CA)

(21) Appl. No.: 17/449,059

(22) Filed: Sep. 27, 2021

(51) Int. Cl. F42B 5/188; C08G 18/78; F42B 5/192; F42B 5/16; C08G 64/02

(52) U.S. Cl. CPC F42B 5/188; C08G 18/7856; C08G 64/0241; F42B 5/16; F42B 5/192

(57) ABSTRACT

Small-, medium-, and large-caliber combustible cartridge cases and propellant combustible containers that are manufactured using reactive injection molding of azido polymers. An injection process for a single propellant combustible charge including the steps of: providing a quantity of azido bearing polymer; providing a quantity of curing agent; optionally providing a quantity of chemical blowing agent; optionally providing a quantity of fibers; optionally providing a quantity of additives and catalysts; and providing a mold defining a male cavity, a female cavity, and an injection port. The injection process further includes mixing together the azido bearing polymer, the curing agent, the optional chemical blowing agent, the optional fibers, the optional additives and catalysts, and injecting the resulting mixture into the mold.

### TECHNICAL FIELD

The present disclosure generally relates to combustible containers. More particularly, the present disclosure relates to small-, medium-, and large-caliber combustible cartridge cases and propellant combustible containers that are manufactured using reactive injection molding of azido polymers.

### BACKGROUND

Small-, medium-, and large-caliber combustible containers are used in both direct and indirect fire applications. Some prior art examples of combustible containers include caseless ammunition that contain a round solid pellet powder charge surrounding the bullet. The lack of cases allows for reduced weight ammunition, but the exposed propellant reduces heat sensitivity, reduces the sealing of the combustion chamber, and reduces protection against air, water, lubricants, and solvents. Also, the fact that the propellant charge must provide structural properties is limiting in both its geometrical shape and in its chemical formulation, thus limiting the combustion properties of the propellant charge.

Further prior art examples of combustible containers include various numbers of cloth increment bags containing various amounts of propellant. The bags are marked and tied to one another ensuring a quick and easy way for the soldier to remove the appropriate amount of propellant to accommodate range limitations and operational requirements. The cloth bag, however, does not allow for an efficient protection with regard to the elements (water, mud, rain, snow, etc.), and for this reason the propellant may be destroyed on site. Training activities of armed forces often result in the destruction of a large quantity of such propellant, which is a potential source of pollution for ranges and training areas.

Still further prior art examples of combustible containers include two distinct propellant charge modules. Each module consists of a three-piece combustible cartridge case design and a bi-directional center core ignition system. The combustible cartridge cases are manufactured using the felting process. The felting process involves the preparation of nitrocellulose fibers, the making of an aqueous slurry of the nitrocellulose fibers, the molding of the pulp, the drying of the preform, and a series of post drying steps to improve properties such as: water resistance, chemical resistance, thermal stability, abrasion, and scuffing. The felted process allows for a rigid container with good combustion properties to be obtained, but it suffers from the following limitations: (a) high manufacturing cost due to multi-steps process, (b) high reject rate associated with poor deposition of the pulp, (c) high quality control cost, and (d) safety issues associated the post drying steps and the presence of solvent and volatile organic compounds.

Accordingly, it would be desirable to provide a manufacturing process for rigid combustible propellant containers for small-, medium-, and large-caliber applications using an affordable single-step shaping process. Additionally, it would be desirable to provide a method of manufacturing rigid combustible propellant containers that are impervious to the elements, thus allowing soldiers to easily manipulate the propellant charge in an economical way. Furthermore, other desirable features and characteristics of the various embodiments described herein will become apparent from the subsequent detailed description and the appended claims, taken in conjunction with the accompanying drawings and this background.

### SUMMARY

The present disclosure provides small-, medium-, and large-caliber combustible cartridge cases and propellant combustible containers that are manufactured using reactive injection molding of azido polymers. In one exemplary embodiment, provided is an injection process for a single propellant combustible charge including the steps of: providing a quantity of azido bearing polymer; providing a quantity of curing agent; optionally providing a quantity of chemical blowing agent; optionally providing a quantity of fibers; optionally providing a quantity of additives and catalysts; and providing a mold defining a male cavity, a female cavity, and an injection port. The injection process further includes mixing together the azido bearing polymer, the curing agent, the optional chemical blowing agent, the optional fibers, the optional additives and catalysts, and injecting the resulting mixture into the mold.

In another exemplary embodiment, provided is an injection process for a propellant charge system including a multitude of identical modules including the steps of: providing a quantity of azido bearing polymer; providing a quantity of curing agent; optionally providing a quantity of chemical blowing agent; optionally providing a quantity of fibers; optionally providing a quantity of additives and catalysts; and providing an injection mold defining a male cavity, a female cavity, and an injection port. The injection process further includes mixing together the azido bearing polymer, the curing agent, the optional chemical blowing agent, the optional fibers, the optional additives and catalysts, and injecting the resulting mixture into the mold.

In another exemplary embodiment, provided is an injection process for a propellant charge system including a multitude of non-identical modules including the steps of: providing a quantity of azido bearing polymer; providing a quantity of curing agent; optionally providing a quantity of chemical blowing agent; optionally providing a quantity of fibers; optionally providing a quantity of additives and catalyst; and providing an injection mold defining a male cavity, a female cavity, and an injection port. The injection process further includes mixing together the azido bearing polymer, the curing agent, the optional chemical blowing agent, the optional fibers, the optional additives and catalysts, and injecting the resulting mixture into the mold.

In yet another exemplary embodiment, provided is an injection process for a combustible cartridge case including the steps of: providing a quantity of azido bearing polymer; providing a quantity of curing agent; optionally providing a quantity of chemical blowing agent; optionally providing a quantity of fibers; optionally providing a quantity of additives and catalysts; and providing an injection mold defining a male cavity, a female cavity and an injection port. The injection process further includes mixing together the azido bearing polymer, the curing agent, the optional chemical blowing agent, the optional fibers, the optional additives and catalysts, and injecting the resulting mixture into the mold.

This brief summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWING

The various embodiments will hereinafter be described in conjunction with the following drawing figures, wherein like numerals denote like elements, and wherein:

FIG. 1 illustrates an exploded view of an artillery round having a single propellant combustible charge in accordance with one embodiment of the present disclosure;

FIG. 2 illustrates an exploded view of the single propellant combustible charge in accordance with the embodiment of FIG. 1;

FIG. 3 illustrates an exploded view of an artillery round having multiple identical propellant combustible charge modules in accordance with one embodiment of the present disclosure;

FIG. 4 illustrates an exploded view of a single propellant combustible charge module in accordance with the embodiment of FIG. 3;

FIG. 5 illustrates an exploded view of an artillery round having multiple non-identical propellant combustible charge modules in accordance with one embodiment of the present disclosure; and

FIG. 6 illustrates an exploded view of a medium-caliber round having an injected azido polymer combustible casing in accordance with one embodiment of the present disclosure.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

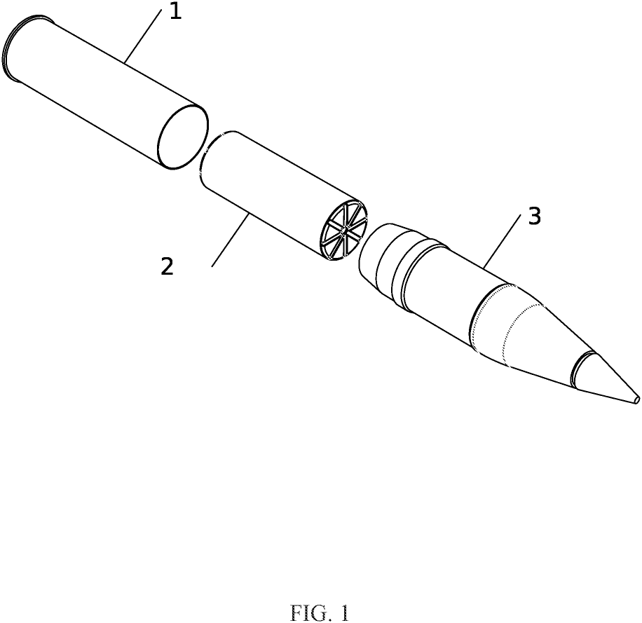

Various embodiments of the present disclosure are directed to the manufacturing of propellant combustible containers and combustible cartridge cases using reaction injection molding of azido polymers. The described embodiments, illustrated in FIGS. 1 - 6, have the advantage of allowing the production of rigid propellant containers with adjustable burning properties and combustible cartridges having intricate geometries using a safe and cost-effective manufacturing processes.

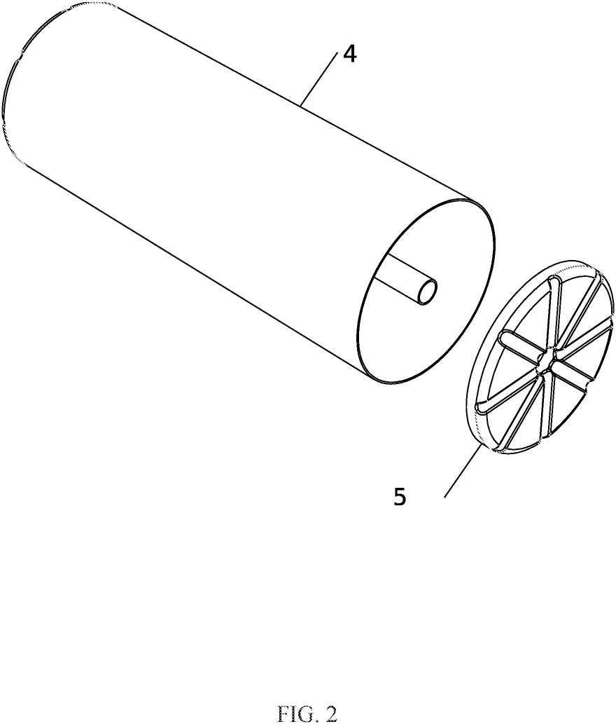

Turning now to the figures, the arrangement in FIG. 1 illustrates a case and primer assembly (1), a propellant charge assembly that includes a single combustible case (2), and a projectile and fuse assembly (3). With additional reference now to FIG. 2, the propellant charge assembly (2) may be assembled from a top part (4) and a bottom part (5).

The top part (4) and the bottom part (5) may be manufactured by providing a quantity of an azido polymer (such as a glycidyl azide polymer, for example, or others known in the art), a curing agent (such as bis(propargyl)succinate, for example, or others known in the art), a mixing vessel, an injection apparatus, and a temperature controlled mold defining a male cavity and a female cavity, shaped in accordance with the top part (4) and the bottom part (5). The manufacturing process for the top part (4) and the bottom part (5) includes mixing the azido polymer and curing agent in the mixing vessel until a thoroughly homogenized mixture is obtained. The manufacturing process thereafter includes transferring the homogenized mixture into the injection apparatus, connecting the injection apparatus to a cavity injection port of the temperature controlled mold, injecting the homogenized mixture into the cavity through the injection port, and allowing the homogenized mixture to cure.

In some embodiments, optionally, a foaming agent (such as a polyether polydimethylsiloxane copolymer, for example, or others known in the art) in solid or solution form may be added to the mixing vessel and incorporated into the azido polymer mixture. In further embodiments, optionally, the mixing may be performed under vacuum to avoid the formation of occlusions in the top part (4) and the bottom part (5). In still further embodiments, optionally, reinforcing fillers and/or additives (such as hexamethylene diisocyanate, for example, or others known in the art) may be added to the mixture to influence the mechanical properties and combustion properties of the finished parts (4) and (5). The assembly of the top part (4) and bottom part (5) to provide the propellant charge assembly that includes the single combustible case (2) may be performed by mixing a small quantity of the homogenized mixture and applying it at the joint between the top part (4) and bottom part (5) after a propellant is added to the top part (4).

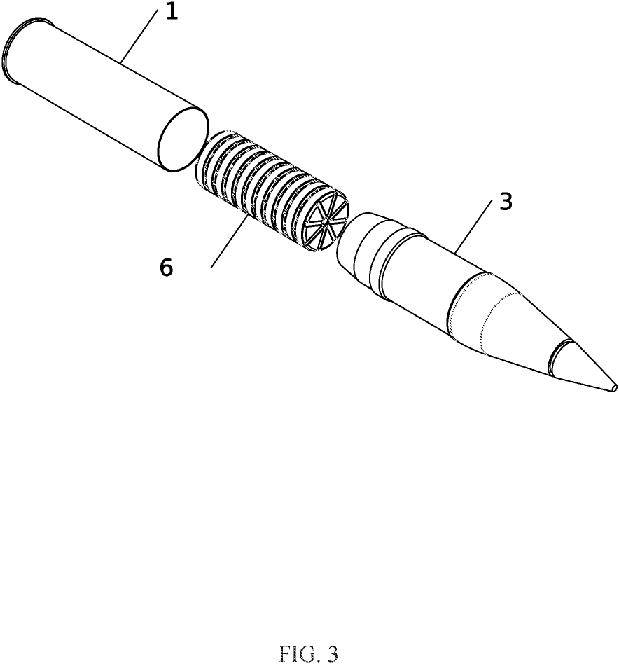

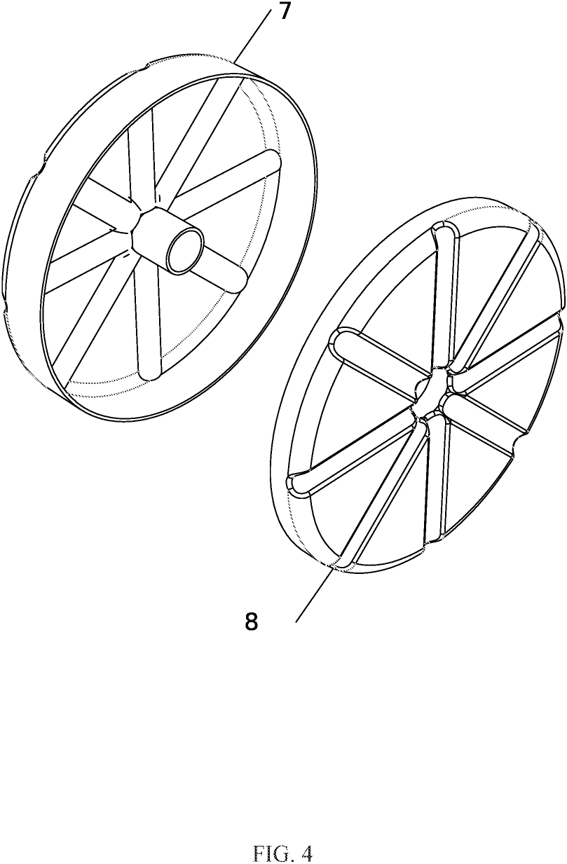

Turning now to FIG. 3, the arrangement in FIG. 3 illustrates another exemplary embodiment of the present disclosure. In FIG. 3, provided are a primer assembly (1), a propellant charge assembly that includes multiple identical combustible case modules (6), and a projectile and fuse assembly (3). With further reference now to FIG. 4, the propellant charge assembly that includes multiple identical combustible case modules (6) may be manufactured from the assembly of multiple identical containers. The identical case modules (6) are an assembly of a bottom part (7) and a top part (8).

The bottom part (7) and the top part (8) may be manufactured by providing a quantity of an azido polymer, a curing agent, a mixing vessel, an injection apparatus, and a temperature controlled mold defining a male cavity and a female cavity, shaped in accordance with the top part (7) and the bottom part (8). The manufacturing process for the top part (7) and the bottom part (8) includes mixing the azido polymer and the curing agent in the mixing vessel until a thoroughly homogenized mixture is obtained. The manufacturing process thereafter includes transferring the homogenized mixture into the injection apparatus, connecting the injection apparatus to a cavity injection port of the temperature controlled mold, injecting the homogenized mixture into the cavity through the injection port, and allowing the homogenized mixture to cure.

In some embodiments, optionally, a foaming agent in solid or solution form may be added to the mixing vessel and incorporated into the azido polymer mixture. In further embodiments, optionally, the mixing may be performed under vacuum to avoid the formation of occlusions in the top part (7) and the bottom part (8). In still further embodiments, optionally, reinforcing fillers and/or additives may be added to the mixture to influence the mechanical properties and combustion properties of the finished parts (7) and (8). The assembly of the top part (7) and bottom part (8) to provide the propellant charge assembly that includes multiple identical combustible case modules (6) may be performed by mixing a small quantity of the homogenized mixture and applying it at the joint between the top part (7) and bottom part (8) after a propellant is added to the top part (7).

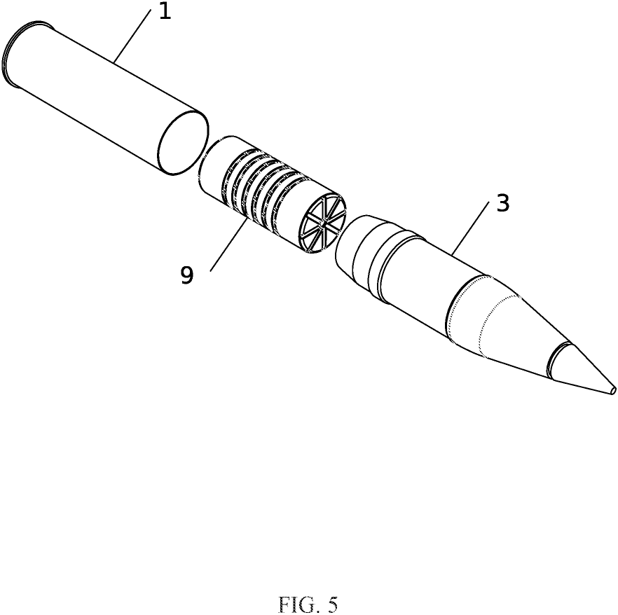

Turning now to FIG. 5, provided is a case and primer assembly (1), a propellant charge assembly that includes multiple non-identical combustible case modules (9), and a projectile and fuse assembly (3). With continued reference to FIG. 5 and further reference back to FIG. 2 and FIG. 4, the propellant charge assembly that includes multiple non-identical combustible module (9) may be manufactured from the assembly of multiple non-identical modules. The non-identical modules are manufactured in the same manner as previously described, with the proviso that different mold geometries are used for each non-identical module.

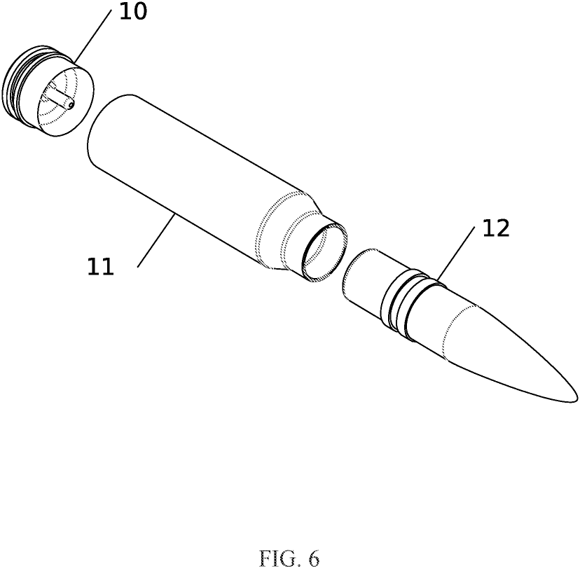

Turning now to FIG. 6, the arrangement in FIG. 6 illustrates another exemplary embodiment of the present disclosure. In FIG. 6, provided are a snub case and primer assembly (10), a combustible cartridge case (11), and a projectile (12).

With reference to FIG. 6, the combustible cartridge case (11) may be manufactured by providing a quantity of an azido polymer, a curing agent, a mixing vessel, an injection apparatus, and a temperature controlled mold defining a male cavity and a female cavity, shaped in accordance with the combustible cartridge case (11). The manufacturing process mixing the azido polymer and the curing agent in the mixing vessel until a thoroughly homogenized mixture is obtained. The manufacturing process thereafter includes transferring the homogenized mixture into the injection apparatus, connecting the injection apparatus to a cavity injection port of the temperature controlled mold, injecting the homogenized mixture into the cavity through the injection port, and allowing the homogenized mixture to cure.

In some embodiments, optionally, a foaming agent in solid or solution form may be added to the mixing vessel and incorporated into the azido polymer mixture. In further embodiments, optionally, the mixing may be performed under vacuum to avoid the formation of occlusions in the combustible cartridge case (11). In still further embodiments, optionally, reinforcing fillers and additives may be added to the mixture to influence the mechanical properties and combustion properties of the finished part (11). The assembly of the ammunition may be performed by mixing a small quantity of mixture and applying it at the joint between the snub case and primer assembly (10) and combustible cartridge case (11). Once a propellant is added to the combustible cartridge case (11) a small quantity of the homogenized mixture and applying it at the joint between the combustible cartridge case (11) and projectile (12) is seated in place.

### ILLUSTRATIVE EXAMPLES

The present disclosure is now illustrated by the following non-limiting examples. It should be noted that various changes and modifications can be applied to the following examples and processes without departing from the scope of this disclosure, which is defined in the appended claims. Therefore, it should be noted that the following example should be interpreted as illustrative only and not limiting in any sense.

In a jacketed stainless steel mixing chamber, 100.0 g of glycidyl azide polymer having a hydroxyl value of less than 1.9, 2.5 g of TEGOSTAB® B 8462, 0.6 g of water and 0.3 g of dibutyltin dilaurate as a calatyst are mixed until thoroughly homogenized. The jacketed stainless steel mixing chamber temperature profile is adjusted every 30 minutes to ensure safe processing and avoid exothermic reaction. During the mixing, 70.0 g of bis(propargyl)succinate are added in equal increments for 180 minutes. 3.1 g of hexamethylene diisocyanate are then added.

The mixture is transferred in an injection device, the device is attached to the injection port of a mold to form the bottom part (7) of combustible charge module (6) as depicted in FIG. 4. A portion of the mixture is injected in the mold. The injection device is then attached to the injection port of the mold to form the top part (8) of combustible charge module (6) as depicted in FIG. 4. Using a circulatory heater, heat-transfer fluid is flowed in the double wall of the mold to cure the mixture. The temperature of the heat-transfer fluid is 77° C. The mixture is allowed to cure overnight obtaining a rigid bottom part (7) and top part (8). The bottom part (7) and the top part (8) are trimmed to remove excess material. The bottom part (7) is filled with propellant. A quantity of the mixture is added to the outside edge of the top part (8). The top part top part (8) is placed so that an efficient seal is obtained encasing the propellant in the rigid combustible charge module (6). Multiple charge modules (6) are then fitted inside the case and primer assembly (1). The projectile and fuse assembly (3) is then seated on the case and primer assembly (1).

In a jacketed stainless steel mixing chamber, 8.0 g of glycidyl azide polymer having a hydroxyl value of less than 1.9, 2.0 g of glycidyl azide polymer having a hydroxyl value of more than 2, 0.15 g of TEGOSTAB® B 8513, 0.06 g of water as a foaming agent and 0.003 g of dibutyltin dilaurate as a catalyst in solution are mixed until thoroughly homogenized. The jacketed stainless steel mixing chamber temperature profile is adjusted every 30 minutes to ensure safe processing and avoid exothermic reaction. During the mixing, 5.5 g of bis(propargyl)malonate are added in equal increment for 180 minutes. 0.4 g of hexamethylene diisocyanate is then added.

The mixture is transferred in an injection device, the device is attached to the injection port of a mold to form the bottom part (7) of combustible charge module (6) as depicted in FIG. 4. A portion of the mixture is injected in the mold. The injection device is then attached to the injection port of a mold to form the top part (8) of combustible charge module (6) as depicted in FIG. 4. Using a circulatory heater, heat-transfer fluid is flowed in the double wall of the mold to cure the mixture. The temperature of the heat-transfer fluid is 77° C. The mixture is allowed to cure overnight obtaining a rigid bottom part (7) and top part (8). The bottom part (7) and the top part (8) are trimmed to remove excess material. The bottom part (7) is filled with a propellant. A quantity of the mixture is then added to the outside edge of the top part (8). The top part top part (8) is placed so that an efficient seal is obtained encasing the propellant in the rigid combustible charge module (6). Multiple charge modules (6) are then fitted inside the case and primer assembly (1). The projectile and fuse assembly (3) is then seated on the case and primer assembly (1).

In the non-limiting examples provided above, the variation in processing conditions allows for control over properties at the mixing and injection steps as well as control over the mechanical, burning behavior, and overall energetic contribution of the finished part.

Accordingly, the present disclosure has provided various embodiments directed to the manufacturing of propellant combustible containers and combustible cartridge cases using reaction injection molding of azido polymers. The described embodiments beneficially provide a manufacturing process for rigid combustible propellant containers for small-, medium-, and large-caliber applications using an affordable single-step shaping process. Furthermore, the described embodiments provide a method of manufacturing rigid combustible propellant containers that are impervious to the elements, thus allowing soldiers to easily manipulate the propellant charge in an economical way.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. An injection process for a combustible part comprising the steps of:
providing a quantity of azido bearing polymer;
providing a quantity of curing agent;
providing a mold defining a male cavity, a female cavity, and an injection port;
mixing together the azido bearing polymer and the curing agent; and
injecting the resulting mixture into the mold.

2. The injection process of claim 1, wherein the mold defines a top part and a bottom part of the combustible part.

3. The injection process of claim 2, further comprising removing the top part and the bottom part from the mold and joining together the top part and the bottom part using a quantity of the mixture to form the combustible part.

4. The injection process of claim 3, wherein the combustible part comprises a single propellant charge.

5. The injection process of claim 3, wherein the combustible part comprises a single propellant module.

6. The injection process of claim 3, wherein the combustible part comprises multiple identical propellant combustible charge modules.

7. The injection process of claim 3, wherein the combustible part comprises multiple non-identical propellant combustible charge modules.

8. The injection process of claim 1, further comprising mixing together with the azido bearing polymer and the curing agent a quantity of a chemical blowing agent.

9. The injection process of claim 1, further comprising mixing together with the azido bearing polymer and the curing agent a quantity of fibers.

10. The injection process of claim 1, further comprising mixing together with the azido bearing polymer and the curing agent a quantity of one or more additives.

11. The injection process of claim 1, further comprising mixing together with the azido bearing polymer and the curing agent a quantity of one or more catalysts.

12. The injection process of claim 1, wherein the mold defines a combustible cartridge case.

13. The injection process of claim 1, further comprising assembling the combustible cartridge assembly into an artillery round with a case and primer assembly and a projectile and fuse assembly.

14. The injection process of claim 1, further comprising assembling the combustible cartridge assembly into an artillery rough with a snub case and primer assembly and a projectile.

15. The injection process of claim 1, wherein the combustible cartridge assembly is in the form of small-, medium-, or large-caliber.
